(19) United States
(12) Patent Application Publication
(10) Pub. No.: US 2005/0168425 A1
(43) Pub. Date: Aug. 4, 2005

(54) Driving circuit for a display device

(76) Inventors: Naoki Takada, Yokohama (JP); Yoshihisa Ooishi, Yokohama (JP); Hiroyuki Nitta, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/011,143

(22) Filed: Dec. 15, 2004

(30) Foreign Application Priority Data
Jan. 29, 2004 (JP) 2004-021770

(51) Int. Cl. G09G 3/36

(52) U.S. Cl. 345/94

(57) ABSTRACT

An active matrix type display device is driven by inverting polarities of gray scale voltages every nth rows of a pixel array of the display device where n≧2. The first rows immediately after the inversion of polarities of the gray scale voltages in the respective columns of the pixel array is dispersed within the pixel array in terms of time and space.

### CLAIM OF PRIORITY

The present application claims priority from Japanese application serial no. 2004-021770, filed on Jan. 29, 2004, the content of which is hereby incorporated by reference into this application.

### BACKGROUND OF THE INVENTION

The present invention relates to a driving circuit for a display device having pixels of the active matrix type, and in particular, to a driving circuit for a display device characterized in that the display device is driven in an ac driving scheme which inverts polarities of voltages applied to a liquid crystal material every nth line (n≧2), and in which lines immediately after inversion of the polarities of applied gray scale voltages are dispersed in terms of space and time within a pixel array of the display device.

As an example of a conventional technique, in the every-nth-line polarity-inverting ac driving of a display device, where n≧2, the lines immediately after inversion of polarities of voltages applied to pixels, that is, locations of inversion of polarities of voltages in a direction of columns of a pixel array, are supplied with voltages for a longer time than the remainder of the lines in the pixel array are.

As an example, U.S. 2003/0132903 A1 (JP-A-2003-207760) discloses such a driving technique. In this technique, polarities of gray scale voltages supplied to pixels from driving means are inverted every N lines (N≧2), and the length of time for outputting charging voltages to respective video signal lines from the driving means is configured such that a length of time for outputting gray scale voltages to pixels in the first line immediately after inversion of polarities of the gray scale voltages is made different from that for outputting gray scale voltages to pixels in the lines succeeding the first line, whose polarities are not inverted, that is, the length of time for outputting gray scale voltages to pixels in the first line immediately after inversion of polarities of the gray scale voltages is made longer than that for outputting gray scale voltages to pixels in the lines succeeding the first line, whose polarities are not inverted.

Further, U.S. 2003/0048248 A1 (JP-A-2003-84725) discloses another driving technique. This technique is directed to a method of driving a liquid crystal display device having a plurality of pixels and driving means for outputting a gray scale voltage from among M gray scale voltages (where M≧2) to each of the pixels. In this driving method, polarities of gray scale voltages supplied to the respective pixels from the driving means are inverted every N lines (N≧2), and the values intended for the mth gray scale voltages (where 1<m<M) supplied to respective ones of the pixels from the driving means is configured such that values intended for the mth gray scale voltages supplied to pixels in the first line immediately after inversion of polarities of the gray scale voltages are made different from those for those intended for the mth gray scale voltages supplied to pixels in the lines succeeding the first line, whose polarities are not inverted.

Further, JP-A-11-352462 discloses another driving technique. In this technique, a source driver performs polarity inversion every two horizontal sync periods, and a gate driver also changes respective scanning lines to a high level for pre-scanning, four horizontal sync periods prior to a time when the gate driver changes the respective scanning lines to the high level for writing.

### SUMMARY OF THE INVENTION

In the above-described conventional technique, in the every-nth-line polarity-inverting ac driving of a display device, where n≧2, by applying voltages to the rows immediately after inversion of polarities of the applied voltages for a longer time than to the remainder of the rows in the pixel array, it is expected that insufficiency of writing into the rows immediately after inversion of polarities of the applied voltages is eliminated because the rows immediately after the inversion of polarities are provided with a longer writing time than the remainder of the rows in the pixel array. However, with the above conventional technique, in a case where a sufficient amount of writing is not provided into the rows, horizontal smears are not eliminated.

It is an object of the present invention to provide a display device and its driving circuit which have horizontal smears suppressed by employing a driving control which causes a shift in ac driving by using a difference in timing in units of horizontal-period times between one output and another output.

It is an object of the present invention to provide a display device and its driving circuit which have horizontal smears suppressed by employing the every-nth-line polarity-inverting ac driving, where n≧2, and at the same time dispersing rows immediately after the inversion of polarities of gray scale voltages in the respective columns of the pixel array, that is, locations of inversion of polarities of the applied voltages in a direction of columns of the pixel array, within the pixel array in terms of space and time.

There are two representative types in the every-nth-line polarity-inverting ac driving of a display device in accordance with the present invention.

In one of the two representative types, in one same frame, rows immediately after the inversion of polarities of gray scale voltages in the respective columns of the pixel array, that is, locations of inversion of polarities of the applied voltages in a direction of columns of the pixel array, are displaced from each other when the rows are viewed in a direction of the rows of the pixel array, and therefore the rows immediately after the inversion of polarities of gray scale voltages in the respective columns of the pixel array, that is, the locations of inversion of polarities of the applied voltages in the direction of columns of the pixel array are dispersed spatially.

In another of the two representative types, in one same frame, rows immediately after the inversion of polarities of gray scale voltages in the respective columns of the pixel array, that is, locations of inversion of polarities of the applied voltages in a direction of columns of the pixel array, are displaced from each other when the rows are viewed in a direction of the rows of the pixel array, and at the same time the rows immediately after the inversion of polarities of gray scale voltages in the respective columns of the pixel array are shifted in the direction of the columns, and consequently, the rows immediately after the inversion of polarities of gray scale voltages in the respective columns of the pixel array are dispersed in terms of space and time.

The present invention is capable of reducing power consumption in the display device driving system by the every-nth-line polarity-inverting ac driving where n≧2, and is also capable of suppressing of occurrence of horizontal smears by dispersing the rows immediately after the inversion of polarities of gray scale voltages, the locations of inversion of polarities of the applied voltages in a direction of columns of a pixel array, within the pixel in terms of space and time.

### BRIEF DESCRIPTION OF THE DRAWINGS

In the accompanying drawings, in which like reference numerals designate similar components throughout the figures, and in which:

FIG. 1 is a schematic illustration of a pixel array provided in an active matrix type display device in accordance with the present invention;

FIG. 2 is a block diagram schematically illustrating a liquid crystal display system in accordance with a first example of the present invention;

FIG. 3 is a schematic illustration for explaining a 6×4 line-inverting ac driving in accordance with the first example of the present invention;

FIG. 4 illustrates timing charts of input and output signals of a data driver in the 6×4 line-inverting ac driving in accordance with the first example of the present invention;

FIG. 5 illustrates distributions of polarities of gray scale voltages in a liquid crystal display device in the 6×4 line-inverting ac driving in accordance with the first example of the present invention;

FIG. 6 illustrates distributions of polarities of gray scale voltages in a liquid crystal display device in the 6×4 line-inverting ac driving in accordance with a second example of the present invention;

FIG. 7 illustrates distributions of polarities of gray scale voltages in a liquid crystal display device in the 6×4 line-inverting ac driving in accordance with a third example of the present invention;

FIG. 8 is a block diagram schematically illustrating a liquid crystal display system in accordance with a fourth example of the present invention;

FIG. 9 is a block diagram schematically illustrating a liquid crystal display system in accordance with a fifth example of the present invention;

FIG. 10 is a block diagram schematically illustrating a liquid crystal display system in accordance with a sixth example of the present invention;

FIG. 11 is a schematic illustration for explaining a 6×4 line-inverting ac driving in accordance with the sixth example of the present invention;

FIG. 12 illustrates distributions of polarities of gray scale voltages in a liquid crystal display device in the 6×4 line-inverting ac driving in accordance with the sixth example of the present invention; and

FIG. 13 illustrates distributions of polarities of gray scale voltages in a liquid crystal display device in the 6×4 line-inverting ac driving in accordance with the seventh example of the present invention.

### DETAILED DESCRIPTION OF THE PREFERRED EMBODIMENTS

In the following, the specific embodiments of the display device and the method of driving it in accordance with the present invention will be explained by reference to several examples and the accompanying drawings. The same reference numerals or characters designate functionally similar parts or portions throughout the figures, and repetition of their explanation is omitted.

Since the liquid crystal display device can be thought to be most generally used among various kinds of display devices now, the following explanation is given using the liquid crystal display device as a representative example of display devices. Therefore the present invention is also applicable to display devices other than liquid crystal display devices, such as organic EL (Electroluminescent) display devices, display devices employing light emitting diodes.

In the following examples, the display devices in accordance with the present invention are described as liquid crystal display devices producing images in the normally black mode, and the display devices in accordance with the present invention can be realized by liquid crystal display devices which produce images in the normally white mode with their pixel configuration modified from that for the normally black mode.

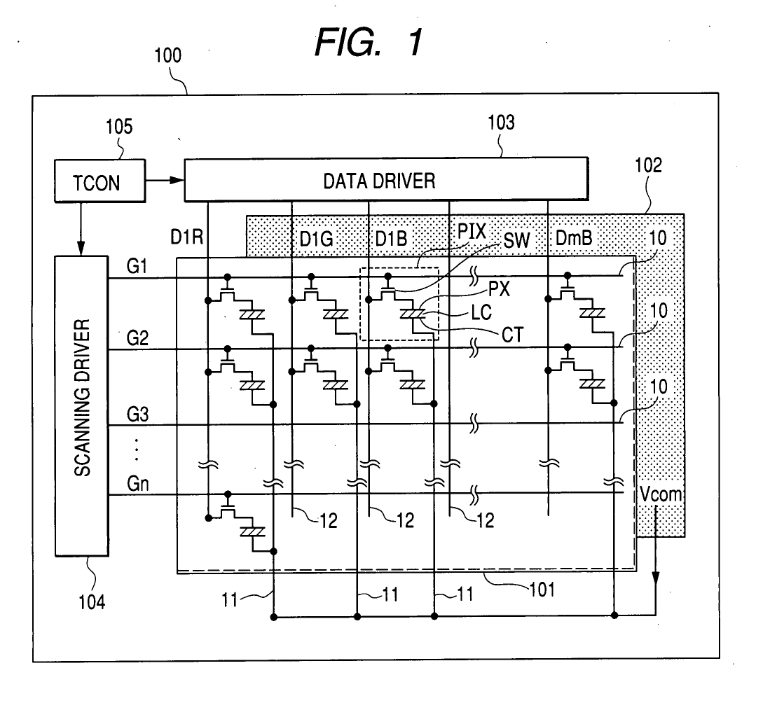

The following will explain a first example by reference to FIGS. 1 to 5. The feature of the first example is that, in the active matrix type liquid crystal display device, an every-nth-line polarity-inverting ac driving is performed where n>1, and that, at the same time, rows immediately after the inversion of polarities of gray scale voltages in the respective columns of the pixel array, that is, locations of inversion of polarities of the applied voltages in a direction of columns of the pixel array, are displaced from each other when the rows are viewed in a direction of the rows of the pixel array.

Particularly in the first example, the rows immediately after the inversion of polarities of gray scale voltages in the respective columns of the pixel array shift by one row in the direction of the columns on successive frames, and the polarities of the voltages applied to the respective pixels are always inverted every three frames or more. It is thought that high-quality images are realized in the liquid crystal display devices which go on increasing in size because the above-explained features reduce consumption of currents in the data driver 103, thereby eliminate generation of heat in the data driver 103, and eliminate occurrence of horizontal smears in the liquid crystal display device.

In this specification, ac driving means inverting polarities of gray scale voltages supplied to pixels, that is, changing a positive voltage difference in the pixels to a negative voltage difference in the pixels, and changing a negative voltage difference in the pixels to a positive voltage difference in the pixels.

The amount of the above-explained shift in the direction of the columns of the pixel array on successive frames is not limited to one row, but it may be selected to be two rows or three rows.

FIG. 1 illustrates a configuration of the active matrix type liquid crystal display device 100. As shown in FIG. 1, a pixel electrode PX and a switching element SW (for example, a thin film transistor) for supplying a video signal to the pixel electrode PX are provided in each of a plurality of pixels PIX arranged two-dimensionally or in a matrix fashion. The element having a plurality of pixels PIX arranged in this way is also called a pixel array 101, and the pixel array in the liquid crystal display device is also called a liquid crystal display device panel. In this pixel array, the plural pixels PIX form a so-called screen which displays an image. Juxtaposed in the pixel array 101 shown in FIG. 1 are a plurality of gate lines (also called scanning signal lines) 10 extending horizontally and a plurality of data lines (also called video signal lines) 12 extending vertically (in a direction perpendicular to the gate lines 10).

As shown in FIG. 1, a so-called pixel row comprised of a plurality of pixels PIX arranged horizontally is formed along each of the gate lines 10 labeled G1, G2, G3, . . . . , Gn, and a so-called pixel column comprised of a plurality of pixels PIX arranged vertically is formed along each of the data lines 12 labeled D1R, D1G, D1B, . . . , DmB.

Each of the gate lines 10 supplies voltage signals to the switching elements SW provided in the respective pixels PIX forming a corresponding one of the pixel rows (indicated below one of the gate lines 10 in the case of FIG. 1) from a scanning driver (also called a scan driving circuit) 107, and thereby opens or closes electrical connections between the pixel electrodes PX provided in the respective pixels PIX and corresponding ones of the data lines 12. Also called a line selection or scanning is an operation of controlling a group of switching elements SW provided in a particular pixel row by supplying a voltage signal (a selection voltage) to the group from a corresponding one of the gate lines 10. Here the above-mentioned voltage signal supplied to the gate lines 10 from the scanning driver 104 is also called a scanning signal or a gate signal.

On the other hand, a respective one of the data lines 12 is supplied with a voltage signal which is also called a gray scale voltage or a tone voltage from a data driver 103 which is also called a video signal driving circuit, and supplies the gray scale voltage to one of the pixel electrodes PX in a pixel column corresponding to the respective data line and selected by the scanning signal. Each of the pixel columns is indicated on the right-hand side of each of the data lines 12 in the case of FIG. 1. The data driver 103 is disposed at one side of the pixel array 101. Therefore the data driver 103 can output gray scale voltages for only one pixel row at a time. In a case where a plurality of data drivers are arranged horizontally, all the plural data drivers in combination output gray scale voltages for one pixel row at a time.

In a case where the liquid crystal display device of the above-described configuration is incorporated into a TV apparatus, during one field period of video data (video signals) received in the interlaced scanning mode, or during one frame period of video data received in the progressive scanning mode, the above-mentioned scanning signal is applied to the gate lines G1 to Gn of the gate lines 10 successively, and thereby gray scale voltages generated from video data received during the one field period or frame period are applied successively to groups of pixels each constituting a corresponding pixel row. In each of the pixels PIX, the above-explained pixel electrode PX and a counter electrode CT supplied with a reference voltage from a common electrode 102 or a common voltage via a signal line 11 controls light transmission through a liquid crystal layer LC.

In a case where operation of selecting the gate lines G1 to Gn successively is performed once during each field period of video data or each frame period of video data as described above, theoretically a gray scale voltage applied to a pixel electrode PX of a given pixel during one given field period is retained in the pixel electrode PX until the pixel electrode PX receives another gray scale voltage during the next field period succeeding the one given field period. Consequently, the light transmission (in other words, luminance of the pixel provided with the pixel electrode PX) through the liquid crystal layer LC sandwiched between the pixel electrode PX and the counter electrode CT is maintained constant. A liquid crystal display device is also called a hold-type display device which produces an image by retaining luminance of a pixel during one entire field period, and is distinguished from a so-called impulse-type display device such as a cathode ray tube which generates light by bombarding a phosphor provided in each pixel with an electron beam the instant the display device receives a video signal.

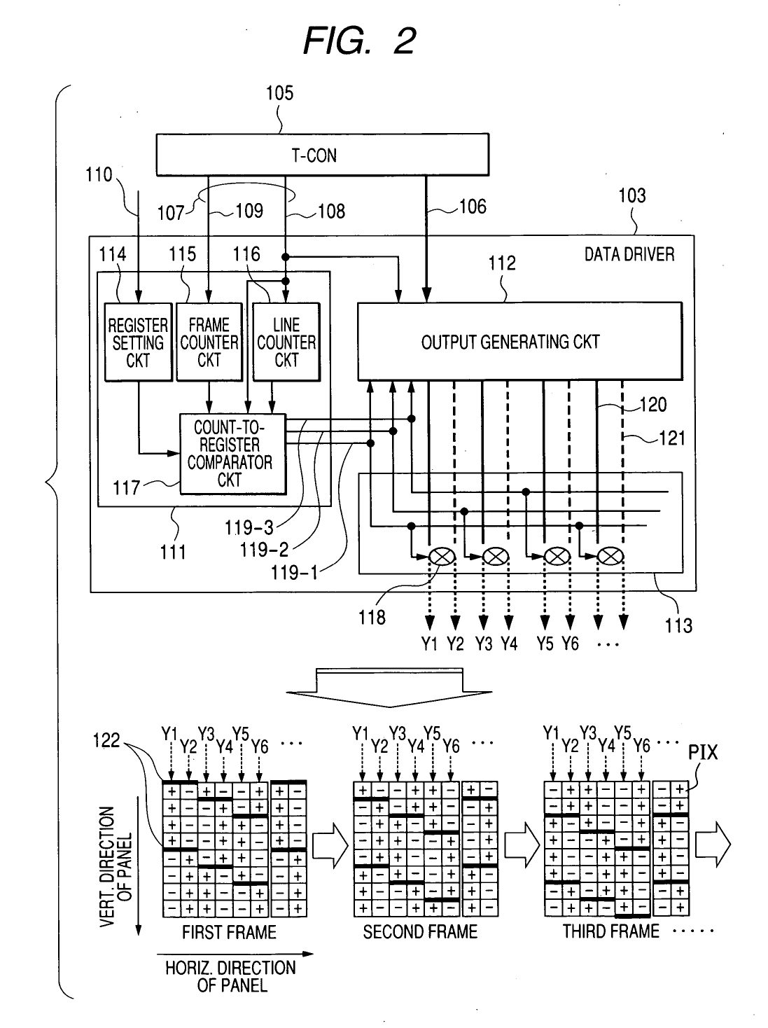

FIG. 2 illustrates a liquid crystal display system of the first example. Included in a data-driver signal group transferred to the data driver 103 from a timing controller (hereinafter T-CON) 105 are a data group included in a driver data 106, and a data-driver-control signal group 107 which includes a horizontal-scanning period signal 108 for the data driver 103 to recognize a horizontal scanning period corresponding to each of the data group, and a vertical-scanning period signal 109 for the data driver 103 to recognize the first scanning period during one vertical scanning period. The data-driver-control signal group 107 also includes a dot clock for the data driver 103 to receive the data group. In addition to the above, a polarity-inverting control signal for ac driving of the liquid crystal display device is one of plural signals which control the liquid crystal display device and are generated by a circuit within the data driver 103. Therefore, inputted to the data driver 103 as the polarity-inverting control signal is a signal 110 for setting a repetition period for every-nth-line polarity-inverting ac driving, and this repetition period setting signal 110 is useful for providing several kinds of repetition periods for the every-nth-line polarity-inverting ac driving. If the every-nth-line polarity-inverting ac driving is performed with the fixed repetition period, a setting-pin input is not needed. A desired setting signal may be supplied to the setting pin from the T-CON 105 as occasion demands. However, it is recommended that a fixing pin is used to fix the repetition period at a high value or a low value. The above explanation has enumerated the minimum number of signals required for the data-driver signal group, and additional signals may be included in the data-driver signal group as occasion demands.

The following will explain the internal configuration of the data driver 103. Provided within the data driver 103 are a polarity-inverting control circuit 111, an output generating circuit 112, and an output-path control circuit 113. The polarity-inverting control circuit 111 is supplied with a vertical-period signal 109, a horizontal-period signal 108, and the signal 110 for setting a repetition period for every-nth-line polarity-inverting ac driving. As described above, only in a case where plural kinds (modes) of the every-nth-line polarity-inverting ac driving are needed, the signal 110 for setting a repetition period via the setting pins are utilized. Outputted from the polarity-inverting control circuit 111 are signals 119-1, 119-2 and 119-3 for changing an output path, the signals 119-1, 119-2 and 119-3 are hereinafter referred to as the output-path-changing signals 119-1, 119-2 and 119-3, and they are used for determining timing in the every-nth-line polarity-inverting ac driving. The polarity-inverting control circuit 111 includes a register setting circuit 114, a frame counter circuit 115, a line counter circuit 116, and a count-to-register comparator circuit 117 for comparing a count with a register value. The polarity-inverting control circuit 111 is supplied with the horizontal-period signal 108, the vertical-period signal 109, and the signal 110 for setting a repetition period for every-nth-line polarity-inverting ac driving. The polarity-inverting control circuit 111 outputs the output-path-changing signals 119-1, 119-2 and 119-3.

The vertical-period signal 109 is supplied to the frame counter circuit 115, which counts the number of frames. The count is supplied to the count-to-register comparator circuit 117.

The horizontal-period signal 108 is supplied to the line counter circuit 116 and the count-to-register comparator circuit 117 for comparing a count with a register value. The line counter circuit 116 counts the number of lines, and the count is supplied to the count-to-register comparator circuit 117 for comparing a count with a register value. The function of the count-to-register comparator circuit 117 in the comparison between the count of the horizontal-period signal 108 and the register value will be described subsequently.

The signal 110 for setting a repetition period for every-nth-line polarity-inverting ac driving is supplied to the register setting circuit 114.

The register setting circuit 114 establishes values of the output-path-changing signals 119-1, 119-2 and 119-3 for the first horizontal-period of a given frame period, and also establishes register values used for determining which lines of the given frame period the output-path-changing signals 119-1, 119-2 and 119-3 is inverted at and what number of lines the output-path-changing signals 119-1, 119-2 and 119-3 is inverted at intervals of. Consequently, polarity-inverting positions in a direction of the columns in each of the columns, that is, a line immediately after the polarity is inverted, is determined based upon the established values of the output-path-changing signals and the register values of the number of lines associated with the repetition period, which have been established in the register setting circuit 114.

The count-to-register comparator circuit 117 compares the information of the register values from the register setting circuit 114 with the frame count supplied from the frame counter circuit 115 and the line count supplied from the line counter circuit 116, and accepts the output-path-changing signals 119-1, 119-2 and 119-3 based upon the horizontal-period signal 108, and thereby determines the state of the output-path-changing signals 119-1, 119-2 and 119-3.

The output-path-changing signals 119-1, 119-2 and 119-3 determine the timing of the polarity inverting for each of different pixel columns. In the first example, the output-path-changing signal 119-1 controls the output paths of the (6m+1)th columns and the (6m+2)th columns, where m is an integer, that is, (Y1 and Y2, Y7 and Y8, . . . ), the output-path-changing signal 119-2 controls the output paths of the (6m+3)th columns and the (6m+4)th columns, that is, (Y3 and Y4, Y9 and Y10, . . . ), and the output-path-changing signal 119-3 controls the output paths of the (6m+5)th columns and the (6m+6)th columns, that is, (Y5 and Y6, Y11 and Y12, . . . ). Each of the output-path-changing signals 119-1, 119-2 and 119-3 is supplied to respective combinations of two adjacent pixel columns. The output-path-changing signals 119-1, 119-2 and 119-3 are supplied to the output generating circuit 112, and to the output-path control circuit 113 via a level shifter.

Supplied to the output generating circuit 112 as its input signals are data group included in the driver data 106, and the dot clock, the horizontal-period signal 108, the output-path-changing signals 119-1, 119-2 and 119-3 which are included in the data-driver-control signal group 107.

The output generating circuit 112 includes a shift register circuit which receives input data group successively from the T-CON 105 in synchronism with the dot clock, a latch circuit which latches the received data for one pixel row at a time in synchronism with the horizontal-period signal 108 and outputs them to a digital-to-analog converter (hereinafter a D/A converter), a voltage generating circuit which generates a plurality of analog data (gray scale voltages) of positive and negative polarities corresponding to a plurality of digital data (display data), and the D/A converter which selects one from among the plural analog data corresponding to the supplied digital data, that is to say, converts the digital data into the analog data.

Here, the D/A converter includes a plurality of pairs of positive D/A converters (hereinafter p-DACs) and negative D/A converters (hereinafter n-DACs). The p-DACs output positive-polarity voltages and the n-DACs output negative-polarity voltages.

The output signals from the output generating circuit 112 are positive-polarity gray scale voltages converted by p-DACs and supplied to positive-polarity gray scale voltage data paths 120 and negative-polarity gray scale voltages converted by n-DACs and supplied to negative-polarity gray scale voltage data paths 121. Two data of each of plural output data pairs (a pair of P1P and P1N, a pair of P2P and P2N, . . . , and a pair of P(n/2)P and P(n/2)N) supplied from the positive-polarity gray scale voltage data paths 120 and the negative-polarity gray scale voltage data paths 121 of the D/A converter, respectively, are output to either of each of plural pairs of odd-numbered and even-numbered outputs (a pair of Y1 and Y2, a pair of Y3 and Y4, . . . , and a pair of Yn-1 and Yn) of the data driver 103, respectively.

For example, when the output data PIP supplied to the positive-polarity gray scale voltage data path 120 is outputted to the output port Y1, the output data PIN supplied to the negative-polarity gray scale voltage data path 121 is outputted to the output port Y2. Incidentally, the output-path-changing signals 119-1, 119-2 and 119-3 will be explained in detail subsequently.

The output-path control circuit 113 is supplied with gray scale voltage data, a pair of P1P and P1N, a pair of P2P and P2N, . . . , and a pair of P(n/2)P and P(n/2)N, which are supplied from the output generating circuit 112 via the positive-polarity gray scale voltage data paths 120 and the negative-polarity gray scale voltage data paths 121, and is also supplied with the output-path-changing signals 119-1, 119-2 and 119-3 inputted from the polarity-inverting control circuit 111 via a level shifter.

The output-path control circuit 113 is provided with an output-path changing circuit 118 which change output paths so that gray scale voltage data pairs supplied from the positive-polarity gray scale voltage data paths 120 and the negative-polarity gray scale voltage data paths 121 are supplied to intended output ports (Y1, Y2, Y3, . . . , Yn).

By way of example, consider the gray scale voltage data P1P intended to be supplied to the output port Y1 via the positive-polarity gray scale voltage data path 120 and the gray scale voltage data P1N intended to be supplied to the output port Y2 via the negative-polarity gray scale voltage data path 121. The output-path changing circuit 118 is controlled by the output-path-changing signals 119-1, 119-2 and 119-3 so that the gray scale voltage data P1P is supplied to the output port Y1 and the gray scale voltage data P1N is supplied to the output port Y2. In the output-path changing circuit 118, the output-path-changing signal 119-1 is used for the pair of the output ports Y1 and Y2, the output-path-changing signal 119-2 is used for the pair of the output ports Y3 and Y4, and the output-path-changing signal 119-3 is used for the pair of the output ports Y5 and Y6. Further, the output-path-changing signal 119-1 is used for the pair of the output ports Y7 and Y8, and so on.

With this configuration, the (6m+1)th and (6m+2)th columns (Y1 and Y2, Y7 and Y8, . . . ) control their output paths by using the output-path-changing signal 119-1, the (6m+3)th and (6m+4)th columns (Y3 and Y4, Y9 and Y10, . . . ) control their output paths by using the output-path-changing signal 119-2, and the (6m+5)th and (6m+6)th columns (Y5 and Y6, Y11 and Y12, . . . ) controls their output paths by using the output-path-changing signal 119-3.

Here, the circuit for changing the output paths for the gray scale voltage data is provided in the output-path control circuit 113, and likewise functionally similar circuits which change data paths are needed in a stage preceding the D/A converters. To put it concretely, when a gray scale voltage data intended for the output port Y1 is supplied as PIP of the data pair from the p-DAC, a digital data corresponding to the gray scale voltage data needs to be supplied to the p-DAC, and at this time a gray scale voltage data intended for the output port Y2 is supplied as PIN of the data pair from the n-DAC, a digital data corresponding to this gray scale voltage data needs to be supplied to the n-DAC. Therefore, it is necessary to supply the output-path-changing signals 119-1, 119-2 and 119-3 to the output generating circuit 112, and to rearrange the data in the shift register circuit or the latch circuit preceding the D/A converter. With this configuration, as in the case of the output-path control circuit 113, the output-path-changing signal 119-1 changes data paths of digital data corresponding to the output ports Y1 and Y2, the output-path-changing signal 119-2 changes data paths of digital data corresponding to the output ports Y3 and Y4, and the output-path-changing signal 119-3 changes data paths of digital data corresponding to the output ports Y5 and Y6.

However, in a case where the data paths of the digital data are changed in the shift register circuit, the timing of rearranging of the digital data having been input to the data driver 103 is displaced by one horizontal-period of time from the timing of outputting from the data driver 103. Therefore, it is necessary to provide a circuit for delaying the output-path-changing signals 119-1, 119-2 and 119-3 which are to be supplied to the output-path changing circuit 118 in the output-path control circuit 113 by one horizontal-period of time, with respect to the output-path-changing signals 119-1, 119-2 and 119-3 supplied to the output generating circuit 112 from the polarity-inverting control circuit 111. For example, a circuit can be used which latches the output-path-changing signals 119-1, 119-2 and 119-3 by using the horizontal-period signal 108.

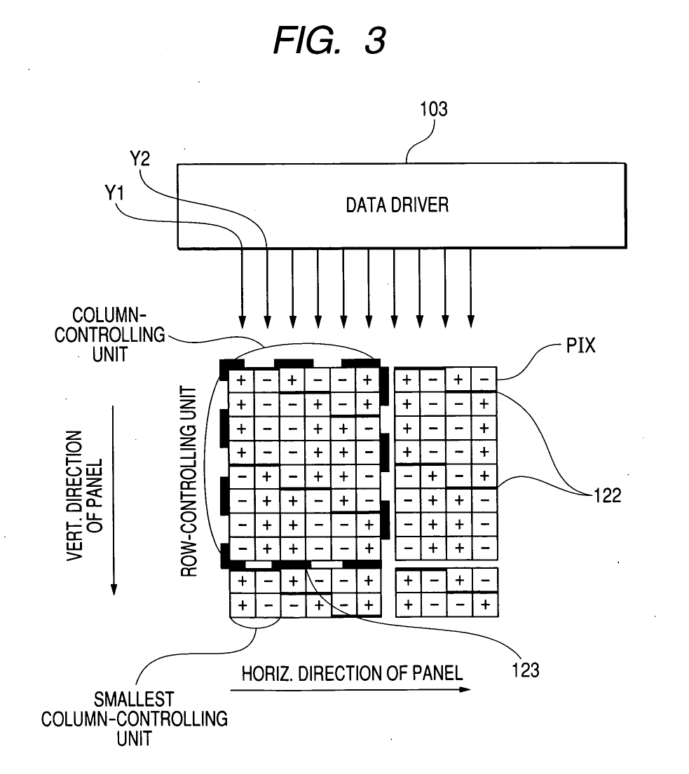

FIG. 3 illustrates a controlling unit for the every-nth-line polarity-inverting ac driving in the liquid crystal display device 100. In the first example, controlling by each of the output-path-changing signals 119-1, 119-2 and 119-3 is performed by making the smallest column-controlling unit of a pair of even-numbered and even-numbered output columns (a pair of the columns Y1 and Y2, a pair of the columns Y3 and Y4, . . . ) among the output ports Y1, Y2, Y3, . . . Yn from the data driver 103 to the liquid crystal display device 100. The column-controlling unit of the output-path-changing signals 119-1, 119-2 and 119-3 is composed of six adjacent columns (Y1 to Y6, Y7 to Y12, . . . ). The output-path-changing signals 119-1, 119-2 and 119-3 have been explained in connection with FIG. 2. The columns controlled by the output-path-changing signals 119-1, 119-2 and 119-3 corresponds to one column-controlling unit. In the first example, six output columns are selected to constitute one column-controlling unit. However, it is not always necessary to select six output columns to be one column-controlling unit, but the number of output columns for one column-controlling unit may be increased or decreased. The above configuration can be modified by changing the number of the output-path-changing signals indicated in FIGS. 2 and 3 using the same algorithm as explained above.

Further, the smallest column-controlling unit is not limited to two columns, but may be selected to be three or four columns. Further, the column-controlling unit is not limited to six columns, but may be selected to be eight or nine columns. However, it is preferable to select the column-controlling unit to be a multiple of the smallest column-controlling unit.

Further, a polarity-inverting row-controlling unit is selected to be eight rows, and is configured to be adjusted by using the signal 110 for setting a repetition period for every-nth-line polarity-inverting ac driving as explained in connection with FIG. 2. In a case where the polarity-inverting row-controlling unit is composed of eight rows, polarities of the voltages applied to the liquid crystal material are inverted every nth rows. Consequently, in the direction of extension of the columns, polarities of the voltages applied to the liquid crystal material are inverted every half of the polarity-inverting row-controlling unit. Incidentally, the polarity-inverting row-controlling unit is not to eight rows, but may be selected to be ten or twelve rows. However, it is preferable to select the polarity-inverting row-controlling unit to be even in number.

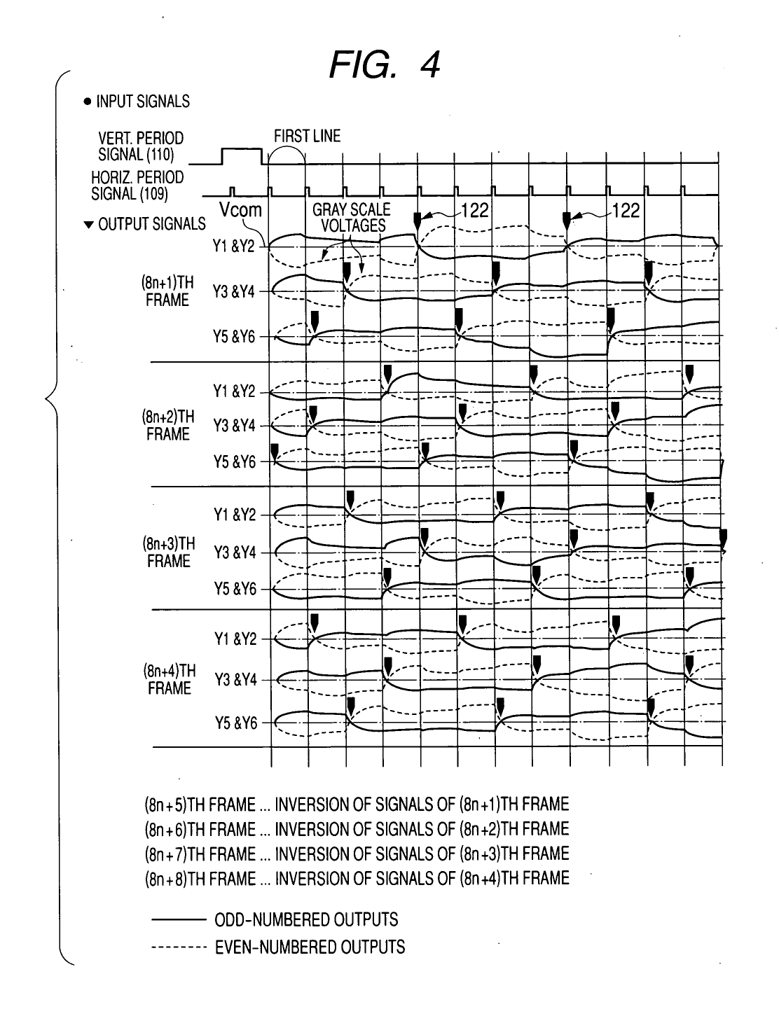

Here, the every-nth-line polarity-inverting ac driving employing the column-controlling unit of M columns and the polarity-inverting row-controlling unit of 2N rows is referred to as the M×N line-inverting ac driving in this specification. Byway of example, the M×N line-inverting ac driving illustrated in FIG. 4 is referred to as the 6×4 line-inverting ac driving.

FIG. 4 illustrates timing charts of input signals to and output signals from the data driver 103 in the 6×4 line-inverting ac driving. The vertical-period signal 109 and the horizontal-period signal 108 are supplied to the data driver 103 as its input signals. The output signals include Y1, Y2, . . . , and Yn. In this specification, the symbols Y1 to Yn are used not only to designate output ports of the data driver 103 but also to represent output signals at the output ports. An even-numbered output and an odd-numbered output forming one pair (a pair of Y1 and Y2, a pair of Y3 and Y4, . . . ) always output gray scale voltages in opposite from each other, respectively. Although output signals other than the output signals Y1 to Y6 are not shown in FIG. 4, they are controlled in the controlling units of the output signals Y7 to Y12, and the output signals Y(n-5) to Yn as in the case of the output signals Y1 to Y6. Ac driving of respective columns during each frame period is controlled by the polarity-inverting control circuit 111 as already explained in connection with FIG. 2.

The following will explain the operation concretely.

In the (8n+1)th frame, first consider a time when the first row of the pixel array 101 is supplied with the output signals Y1 to Y6. The output signal Y1 is a positive voltage with the output signal Y2 being a negative voltage, the output signal Y3 is a positive voltage with the output signal Y4 being a negative voltage, and the output signal Y6 is a positive voltage with the output signal Y5 being a negative voltage. Further, in the columns associated with the output signals Y1 and Y2, the first line immediately after the inversion of polarities of gray scale voltages in the every-nth-line polarity-inverting ac driving is selected to be the first row of the pixel array 101. In the columns associated with the output signals Y3 and Y4, the first line immediately after the inversion of polarities of gray scale voltages in the every-nth-line polarity-inverting ac driving is selected to be the third row of the pixel array 101. In the columns associated with the output signals Y5 and Y6, the first line immediately after the inversion of polarities of gray scale voltages in the every-nth-line polarity-inverting ac driving is selected to be the second row of the pixel array 101. Here the repetition period of the alternating gray scale voltages in the every-nth-line polarity-inverting ac driving is four lines, that is, four rows, in all the columns in all the frame periods.

In the (8n+2)th frame, first consider a time when the first row of the pixel array 101 is supplied with the output signals Y1 to Y6. The output signal Y2 is a positive voltage with the output signal Y1 being a negative voltage, the output signal Y4 is a positive voltage with the output signal Y3 being a negative voltage, and the output signal Y5 is a positive voltage with the output signal Y6 being a negative voltage. Further, in the columns associated with the output signals Y1 and Y2, the first line immediately after the inversion of polarities of gray scale voltages in the every-nth-line polarity-inverting ac driving is selected to be the fourth row of the pixel array 101. In the columns associated with the output signals Y3 and Y4, the first line immediately after the inversion of polarities of gray scale voltages in the every-nth-line polarity-inverting ac driving is selected to be the second row of the pixel array 101. In the columns associated with the output signals Y5 and Y6, the first line immediately after the inversion of polarities of gray scale voltages in the every-nth-line polarity-inverting ac driving is selected to be the first row of the pixel array 101.

In the (8n+3)th frame, first consider a time when the first row of the pixel array 101 is supplied with the output signals Y1 to Y6. The output signal Y1 is a positive voltage with the output signal Y2 being a negative voltage, the output signal Y4 is a positive voltage with the output signal Y3 being a negative voltage, and the output signal Y6 is a positive voltage with the output signal Y5 being a negative voltage. Further, in the columns associated with the output signals Y1 and Y2, the first line immediately after the inversion of polarities of gray scale voltages in the every-nth-line polarity-inverting ac driving is selected to be the third row of the pixel array 101. In the columns associated with the output signals Y3 and Y4, the first line immediately after the inversion of polarities of gray scale voltages in the every-nth-line polarity-inverting ac driving is selected to be the first row of the pixel array 101. In the columns associated with the output signals Y5 and Y6, the first line immediately after the inversion of polarities of gray scale voltages in the every-nth-line polarity-inverting ac driving is selected to be the fourth row of the pixel array 101.

In the (8n+4)th frame, first consider a time when the first row of the pixel array 101 is supplied with the output signals Y1 to Y6. The output signal Y2 is a positive voltage with the output signal Y1 being a negative voltage, the output signal Y3 is a positive voltage with the output signal Y4 being a negative voltage, and the output signal Y6 is a positive voltage with the output signal Y5 being a negative voltage. Further, in the columns associated with the output signals Y1 and Y2, the first line immediately after the inversion of polarities of gray scale voltages in the every-nth-line polarity-inverting ac driving is selected to be the second row of the pixel array 101. In the columns associated with the output signals Y3 and Y4, the first line immediately after the inversion of polarities of gray scale voltages in the every-nth-line polarity-inverting ac driving is selected to be the fourth row of the pixel array 101. In the columns associated with the output signals Y5 and Y6, the first line immediately after the inversion of polarities of gray scale voltages in the every-nth-line polarity-inverting ac driving is selected to be the third row of the pixel array 101.

In the (8n+5)th frame, all the applied voltages are in the same timing as that in the case of the (8n+1)th frame, but are opposite in polarity from those in the case of the (8n+1)th frame.

Likewise, in the (8n+6)th frame, all the applied voltages are in the same timing as that in the case of the (8n+2)th frame, but are opposite in polarity from those in the case of the (8n+2)th frame.

Likewise, in the (8n+7)th frame, all the applied voltages are in the same timing as that in the case of the (8n+3)th frame, but are opposite in polarity from those in the case of the (8n+3)th frame.

Likewise, in the (8n+8)th frame, all the applied voltages are in the same timing as that in the case of the (8n+4)th frame, but are opposite in polarity from those in the case of the (8n+4)th frame.

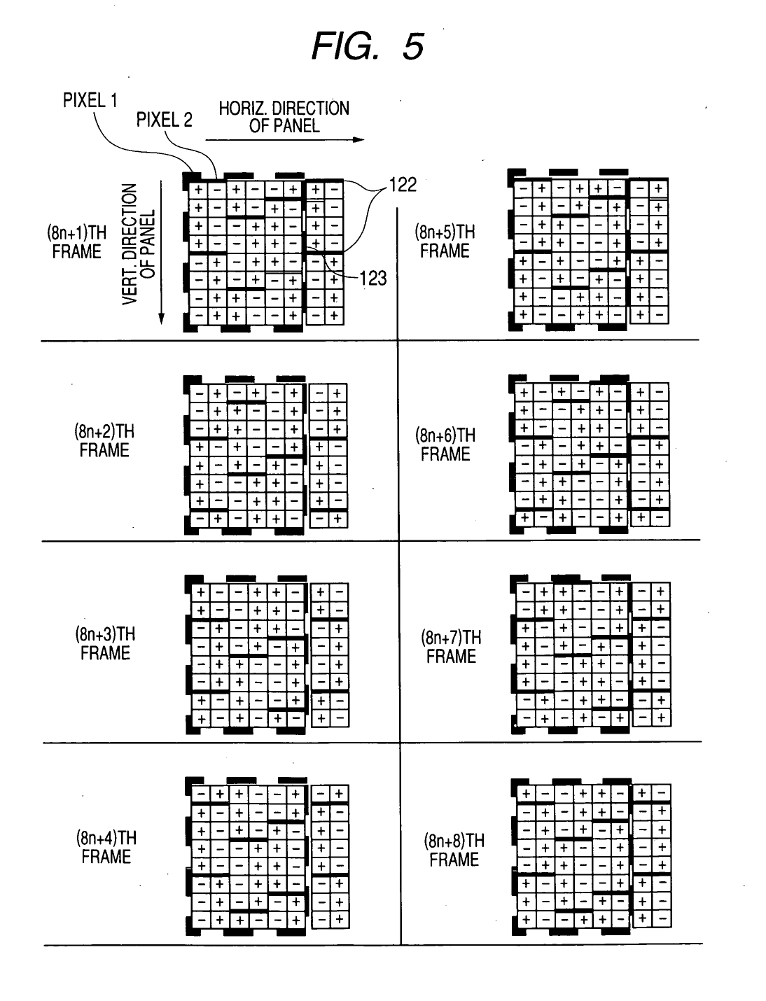

The advantages obtained by applying the voltages of the above-explained waveforms to the respective lines will be explained in connection with FIG. 5. FIG. 5 illustrates a distribution of polarities of voltages applied to respective pixels of the liquid crystal display device 100 in the every-nth-line polarity-inverting ac driving. FIG. 5 illustrates a distribution of polarities of voltages obtained by applying voltages of the polarities represented by the output waveforms illustrated in FIG. 4.

In FIG. 5, the first lines of the respective output signal pairs of (Y1 and Y2), (Y3 and Y4), (Y5 and Y6), immediately after the inversion of polarities of gray scale voltages are never in a line in each of the frames when the first lines are viewed in a direction of the rows of the pixel array. Further, the first line of each of the output signal pairs of (Y1 and Y2), (Y3 and Y4), (Y5 and Y6), . . . , immediately after the inversion of polarities of gray scale voltages are always displaced in a direction of extension of the columns of the pixel array, from the (8m+1)th frame to the (8m+8)th frame. Further, none of the pixels have applied thereto voltages of the same polarity in three successive frames.

It is thought that, by employing the above-explained every-nth-line polarity-inverting ac driving, consumption of currents in the data driver is reduced and thereby generation of heat in the data driver is eliminated, and the above-explained distribution of polarities of gray scale voltages is realized in the liquid crystal display device 100, and that consequently, occurrence of horizontal smears is eliminated in the liquid crystal display device 100, and displaying of high-quality images is realized.

In the following, the second example will be explained by reference to FIGS. 1, 2, 3 and 6. The second example employs the every-nth-line polarity-inverting ac driving in the active matrix type liquid crystal display device 100, and has the features that the first lines of the respective output signal pairs of (Y1 and Y2), (Y3 and Y4), (Y5 and Y6), . . . , immediately after the inversion of polarities of gray scale voltages are never in a line in each of the frames when the first lines are viewed in a direction of the rows of the pixel array. Particularly in the second example, the first lines of the respective output signal pairs of (Y1 and Y2), (Y3 and Y4), (Y5 and Y6), . . . , immediately after the inversion of polarities of gray scale voltages shift in a direction of the extension of the columns every second frame period, and the polarities of the gray scale voltages applied to the pixels in the successive odd-numbered and even-numbered frames, respectively, are opposite from each other, and consequently, the polarities of the gray scale voltages applied to the respective pixels are always reversed on successive frames. It is thought that high-quality images are realized in the liquid crystal display devices which go on increasing in size because the above-explained features reduce consumption of currents in the data driver 103, thereby eliminate generation of heat in the data driver 103, and eliminate occurrence of horizontal smears in the liquid crystal display device.

The liquid crystal display device 100 used in the second example is similar to that illustrated in FIG. 1, and therefore, the explanation of the principle of displaying images by the liquid crystal display device 100 is omitted. The liquid crystal display system in the second example is similar to that illustrated in FIG. 2, and its detailed explanation is omitted. The controlling unit for the every-nth-line polarity-inverting ac driving in the liquid crystal display device 100 of the second example is the same as illustrated in FIG. 3, and its detailed explanation is omitted.

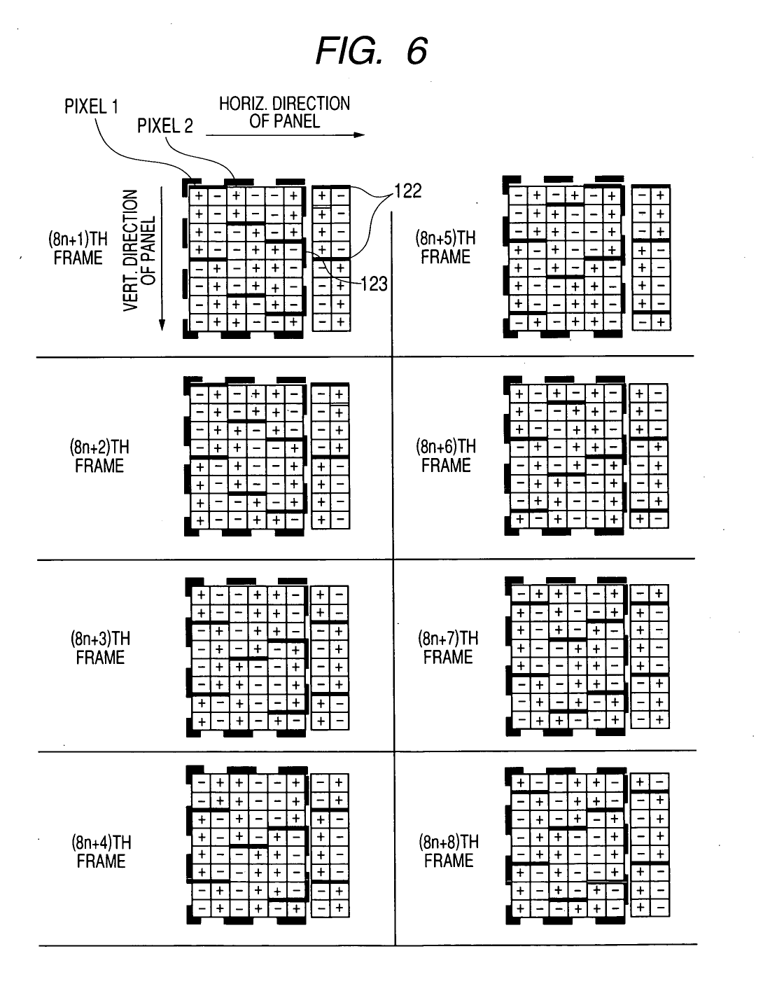

FIG. 6 illustrates a distribution of polarities of voltages applied to respective pixels of the liquid crystal display device 100 in the every-nth-line polarity-inverting ac driving.

The second example differs from the first example in the timing of the output-path-changing signals 119-1, 119-2 and 119-3 generated in the polarity-inverting control circuit 111 in FIG. 2. FIG. 6 illustrates a distribution of polarities of voltages applied to respective pixels of the liquid crystal display device 100 in accordance with the output-path-changing signals 119-1, 119-2 and 119-3 of the second example. The first lines of the respective output signal pairs of (Y1 and Y2), (Y3 and Y4), (Y5 and Y6), . . . , immediately after the inversion of polarities of applied gray scale voltages are never in a line in each of the frames when the first lines are viewed in a direction of extension of the rows of the pixel array. Further, when only the odd-numbered frames, the (8m+1)th , (8m+3)th, (8m+5)th, (8m+7)th frames, . . . , are considered, the first lines of the respective output signal pairs of (Y1 and Y2), (Y3 and Y4), (Y5 and Y6), . . . , immediately after the inversion of polarities of applied gray scale voltages are always shifted in a direction of extension of the columns of the pixel array in three successive odd-numbered frames. Further, in pairs of successive odd-numbered and even-numbered frames, a pair of the (8m+1)th and (8m+2)th frames, a pair of the (8m+3)th and (8m+4)th frames, a pair of the (8m+5)th and (8m+6)th frames, a pair of the (8m+7)th and (8m+8)th frames, . . . , polarities of voltages applied to the respective pixels are always reversed on successive frames, and consequently, voltages of the same polarities are never applied to the same pixels in two successive frames or more.

It is thought that, by employing the above-explained every-nth-line polarity-inverting ac driving, consumption of currents is reduced in the data driver and thereby generation of heat in the data driver is eliminated, and the above-explained distribution of polarities of gray scale voltages is realized in the liquid crystal display device 100, and that consequently, occurrence of horizontal smears is eliminated in the liquid crystal display device 100, and displaying of high-quality images is realized.

In the following, the third example will be explained by reference to FIGS. 1, 2, 3 and 7. The third example employs the every-nth-line polarity-inverting ac driving in the active matrix type liquid crystal display device 100, and has the features that the first lines of the respective output signal pairs of (Y1 and Y2), (Y3 and Y4), (Y5 and Y6), immediately after the inversion of polarities of gray scale voltages are never in a line in each of the frames when the first lines are viewed in a direction of the rows of the pixel array. Particularly in the third example, the first lines of the respective output signal pairs of (Y1 and Y2), (Y3 and Y4), (Y5 and Y6), . . . , immediately after the inversion of polarities of gray scale voltages do not shift in a direction of the extension of the columns on successive frames, and the polarities of the gray scale voltages applied to all the pixels are reversed on successive frames.

It is thought that high-quality images are realized in the liquid crystal display devices which go on increasing in size because the above-explained features reduce consumption of currents in the data driver 103, thereby eliminate generation of heat in the data driver 103, and make it possible to eliminate occurrence of horizontal smears in the liquid crystal display device 100 by using a simple logical design.

The liquid crystal display device 100 used in the third example is similar to that illustrated in FIG. 1, and therefore, the explanation of the principle of displaying images by the liquid crystal display device 100 is omitted. The liquid crystal display system in the third example is similar to that illustrated in FIG. 2, and its detailed explanation is omitted. The controlling unit for the every-nth-line polarity-inverting ac driving in the liquid crystal display device 100 of the third example is the same as illustrated in FIG. 3, and its detailed explanation is omitted.

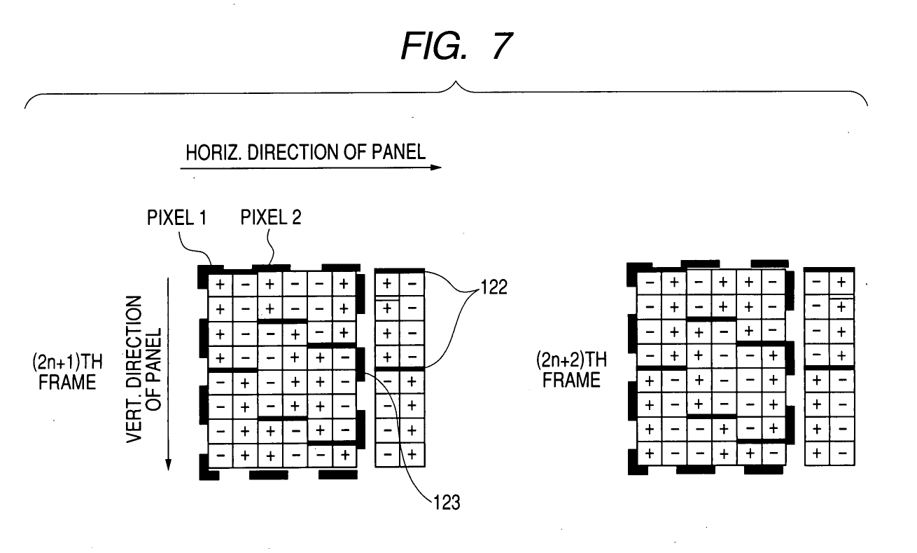

FIG. 7 illustrates a distribution of polarities of voltages applied to respective pixels of the liquid crystal display device 100 in the every-nth-line polarity-inverting ac driving.

The third example differs from the first example in the timing of the output-path-changing signals 119-1, 119-2 and 119-3 generated in the polarity-inverting control circuit 111 in FIG. 2. FIG. 7 illustrates a distribution of polarities of voltages applied to respective pixels of the liquid crystal display device 100 in accordance with the output-path-changing signals 119-1, 119-2 and 119-3 of the third example. The first lines of the respective output signal pairs of (Y1 and Y2), (Y3 and Y4), (Y5 and Y6), . . . , immediately after the inversion of polarities of applied gray scale voltages are never in a line in each of the frames when the first lines are viewed in a direction of extension of the rows of the pixel array. Further, when the odd-numbered frames, the (8m+1)th, (8m+3)th, . . . , and the even-numbered frames, the (8m+2)th, (8m+4)th, . . . are considered, gray scale voltages of the same polarities are never applied to the same pixels in two successive frames or more, because the polarities of the gray scale voltages applied to the respective pixels are always reversed on successive frames.

It is thought that, by employing the above-explained every-nth-line polarity-inverting ac driving, consumption of currents is reduced in the data driver and thereby generation of heat in the data driver is eliminated, and the above-explained distribution of polarities of gray scale voltages is realized in the liquid crystal display device 100, and that consequently, occurrence of horizontal smears is eliminated in the liquid crystal display device 100, and displaying of high-quality images is realized.

In the following, the fourth example will be explained by reference to FIGS. 1, 3 and 8. The features of the fourth example are that the number of required signal lines from the T-CON 105 for driving and controlling the data driver 103 is reduced by providing a different logical circuit within the data driver 103 in addition to realizing the features of the first, second and third example. These features realizes the features of the first, second and third examples without increasing the number of signal lines for the liquid crystal display device 100. It is thought that high-quality images are realized in the liquid crystal display devices which go on increasing in size by reducing consumption of currents in the data driver 103, thereby eliminating generation of heat in the data driver 103, and eliminating occurrence of horizontal smears in the liquid crystal display devices 100.

The liquid crystal display device 100 used in the fourth example is similar to that illustrated in FIG. 1, and therefore, the explanation of the principle of displaying images by the liquid crystal display device 100 is omitted.

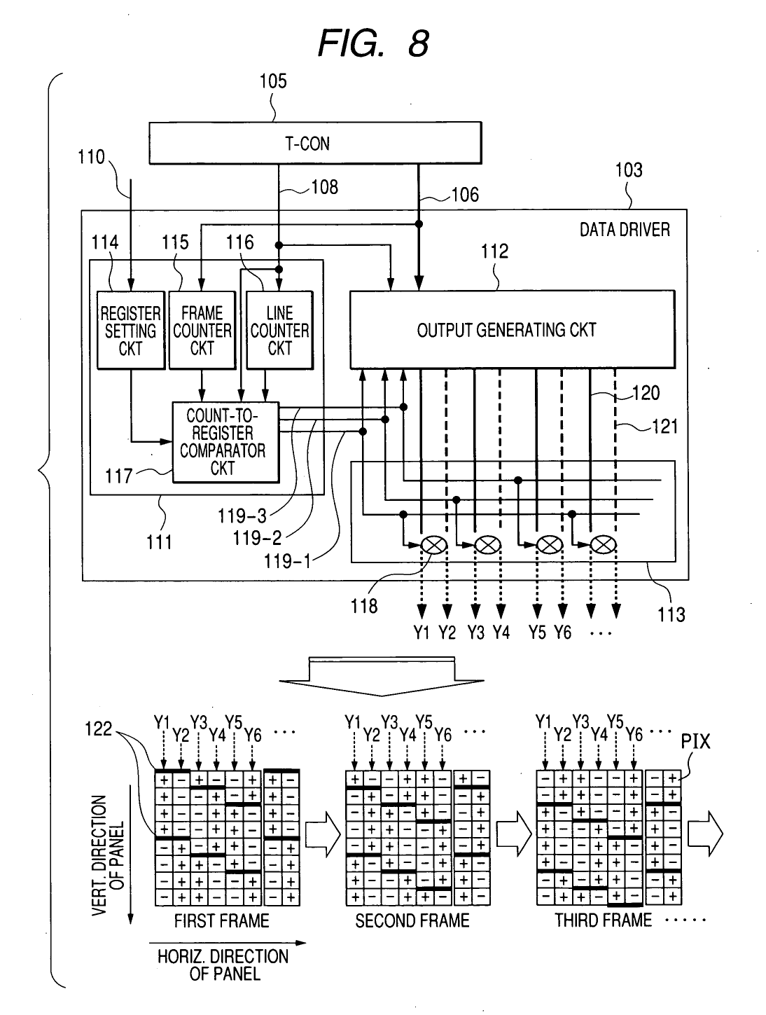

FIG. 8 illustrates the liquid crystal display system in accordance with the fourth example. The polarity-inverting control circuit 111 shown in FIG. 8 has eliminated the vertical-period signal 109 inputted to the data driver 103 from the T-CON 105 explained in the first example using FIG. 2, and use part of the data group 106 transferred from the T-CON 105 as a substitute for the vertical-period signal 105. The signals supplied to the polarity-inverting control circuit 111 of the fourth example include the horizontal-period signal 108, part of the data group 106, and the signal 110 for setting a repetition period for every-nth-line polarity-inverting ac driving. The part of the data group 106 is transferred from the T-CON 105 to the polarity-inverting control circuit 111 within the data driver 103 for the data driver 103 to recognize the time of starting of the first horizontal-period during one vertical period, during the vertical retrace period. With this configuration, the above-mentioned part of the data group 106 performs the same function as the vertical-period signal 109 explained in connection with FIG. 3 for the first example. The remaining functions in the fourth example is similar to those explained in connection with FIG. 2, and their detailed explanations are omitted. The controlling unit for the every-nth-line polarity-inverting ac driving in the liquid crystal display device 100 of the fourth example is similar to that illustrated in FIG. 4, and its detailed explanation is omitted.

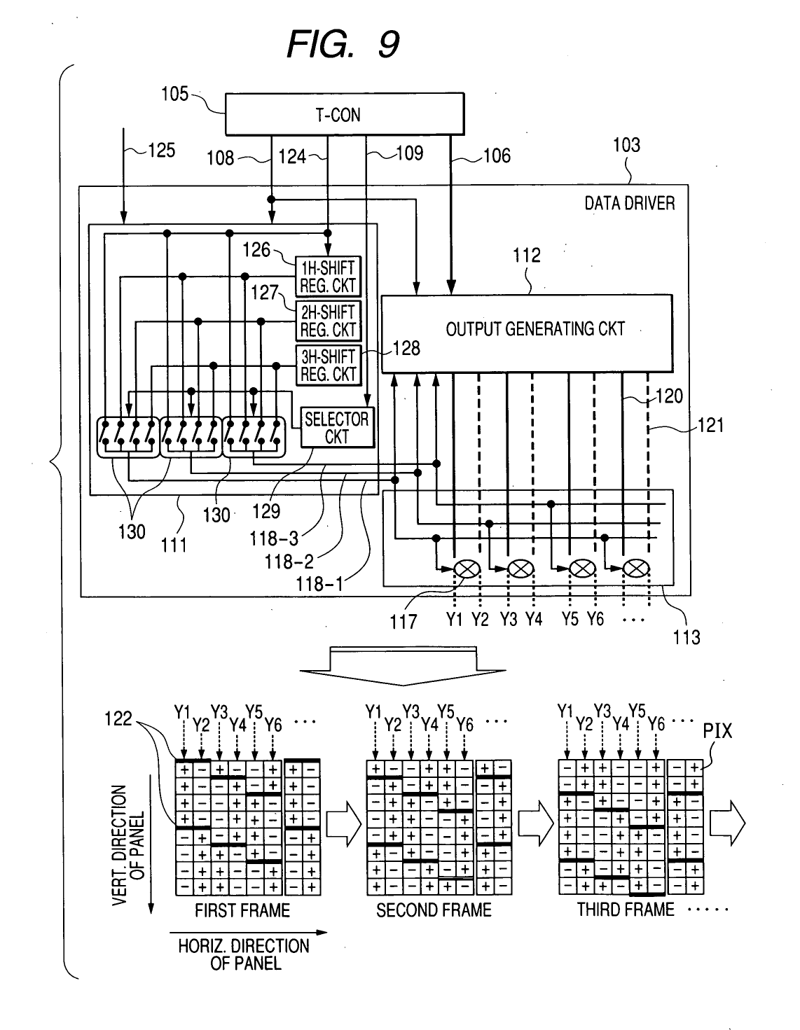

As explained above, the fourth example has changed the polarity-inverting control circuit 111 within the data driver 103 from that illustrated in FIG. 2 to that illustrated in FIG. 9, and consequently, this configuration makes it possible to reduce the number of the data group to be inputted to the data driver 103 from the T-CON 105, and that the liquid crystal display device can be realized which has the features provided by the first, second and third examples.

In the following, the fifth example will be explained by reference to FIGS. 1, 4 and 9. One of the features of the fifth example is that the features of the first, second and third examples are realized by providing shift registers within the data driver 103 for shifting the polarity-inverting control signals. Therefore, it is thought that high-quality images are realized in the liquid crystal display devices which go on increasing in size by reducing consumption of currents in the data driver 103, thereby eliminating generation of heat in the data driver 103, and eliminating occurrence of horizontal smears in the liquid crystal display devices 100.

The liquid crystal display device 100 used in the fifth example is similar to that illustrated in FIG. 1, and therefore, the explanation of the principle of displaying images by the liquid crystal display device 100 is omitted.

FIG. 9 illustrates a liquid crystal display system in accordance with the fifth example. Provided within the data driver 103 in FIG. 9 are the polarity-inverting control circuit 111, the output generating circuit 112, and the output-path control circuit 113. The output generating circuit 112 and the output-path control circuit 113 have been explained in connection with FIG. 2, and their explanations are omitted here.

The following will explain the polarity-inverting control circuit 111 shown in FIG. 9. The polarity-inverting control circuit 111 includes a 1H-shift register circuit 126, a 2H-shift register circuit 127, a 3H-shift register circuit 128, a selector circuit 129, switching circuits 130 for selecting one from among four signals including three signals from the three register circuits 126, 127, 128 and the supplied polarity-inverting control signal 124. In this case, the amounts of shits to be set are equivalents to one, two and three rows, respectively, and they are selected based upon a line-shift-setting signal 125 which sets the amount of shift in number of lines. Further, although the three shift register circuits is employed in this example, the number of the shift registers can be increased or decreased.

The signals supplied to the polarity-inverting control circuit 111 include the horizontal-period signal 108, the polarity-inverting control signal 124, and the line-shift-setting signal 125 which sets the amount of line shift in the case of shifting the polarity-inverting control signal 124 in units of line periods. The signals outputted from the polarity-inverting control circuit 111 are the output-path-changing signals 119-1, 119-2 and 119-3.

The polarity-inverting control signal 124 is supplied to the 1H-shift register circuit 126, the 2H-shift register circuit 127 and the 3H-shift register circuit 128, and the shift registers 126, 127, 128 output the polarity-inverting control signals 124 delayed by the corresponding amounts of shift in units of line numbers. The signals from the three shift registers 126, 127, 128 and the polarity-inverting control signal 124 are supplied to each of the three switching circuits 130. The switching circuits 130 are controlled by the selector circuit 129 so that they select one signal from among the above-mentioned four signals and outputs the signal as the output-path-changing signals 119-1, 119-2 and 119-3, respectively.

The selector circuit 129 is supplied with the vertical-period signal 109 and the line-shift-setting signal 125, and outputs signals for controlling the switching circuits 130. Based upon the vertical-period signal, the selector circuit 129 changes the signals to be selected by the respective ones of the switching circuits 130 on successive frames, based upon information of the line-shift-setting signal 125.

The controlling unit for the every-nth-line polarity-inverting ac driving in the liquid crystal display device 100 of the fifth example is similar to that illustrated in FIG. 4, and its detailed explanation is omitted.

As explained above, in the fifth embodiment, the polarity-inverting control circuit 111 within the data driver 103 is modified as shown in FIG. 9, and with this configuration, the liquid crystal display device 100 having the features of the first, second and third examples can be realized by providing the shift registers within the data driver 103 for shifting the polarity-inverting control signal 124.

In the following, the sixth example will be explained by reference to FIGS. 1, 10, 11 and 12. While two output ports of each of the output pairs having their first lines immediately after the inversion of polarities of gray scale voltages in the same row are adjoining each other in the first to fifth examples, the two output ports of each of the output pairs in the sixth example are displaced from each other by three columns. With this configuration, the sixth example has a feature that further dispersed spatially the first lines immediately after the inversion of polarities of gray scale voltages, in addition to the features of the first, second, third, fourth and fifth examples.

The liquid crystal display device 100 used in the sixth example is similar to that illustrated in FIG. 1, and therefore, the explanation of the principle of displaying images by the liquid crystal display device 100 is omitted.

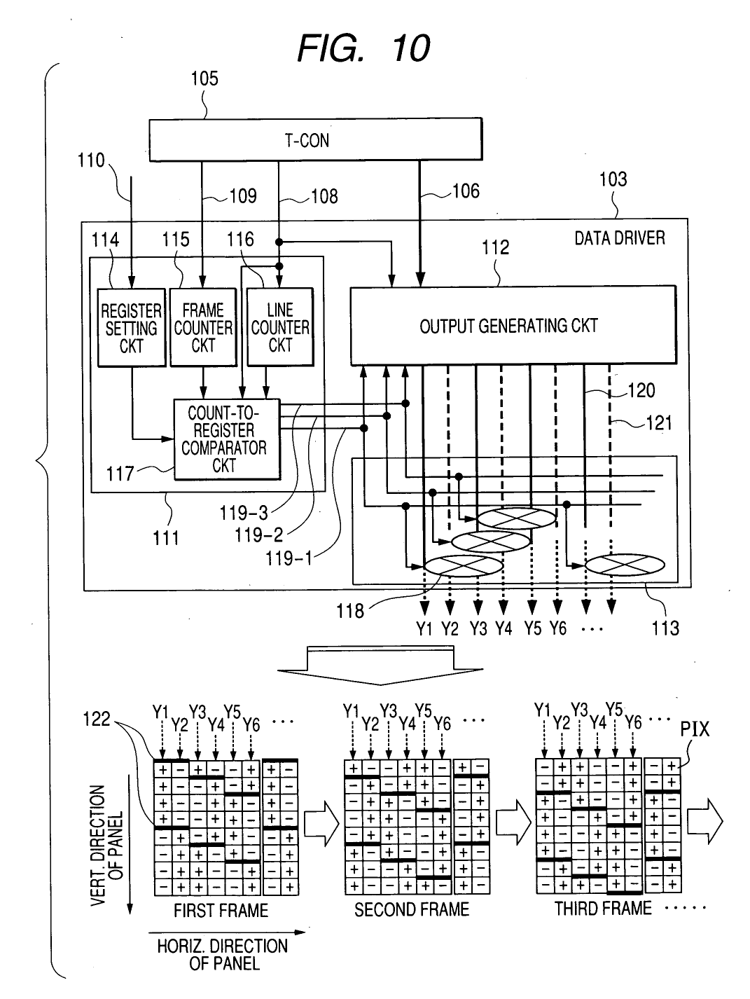

In the following, the liquid crystal display system in the sixth example will be explained by reference to FIG. 10.

As explained in connection with FIG. 2, an output data pair is composed of data supplied via the positive-polarity gray scale voltage data path 120 and the negative-polarity gray scale voltage data path 121 from the output generating circuit 112. In the output-path control circuit 113 shown in FIG. 10, the output data pairs from the positive- and negative-polarity gray scale voltage data paths 120, 121 are considered to be represented as a pair of P1P and P2N, a pair of P2P and P3N, a pair of P3P and P1N, By way of example, the gray scale voltage data P1P to be outputted to the output port Y1 via the positive-polarity gray scale voltage data path 120 and the gray scale voltage data P2N to be outputted to the output port Y4 via the negative-polarity gray scale voltage data path 121 are controlled by an output-path-changing signal which controls the output-path changing circuit 118 so as to provide the data P1P and P1N to the output ports Y1 and Y2, respectively. The gray scale voltage data P3P to be outputted to the output port Y2 via the positive-polarity gray scale voltage data path 120 and the gray scale voltage data P1N to be outputted to the output port Y5 via the negative-polarity gray scale voltage data path 121 are controlled by an output-path-changing signal which controls the output-path changing circuit 118 so as to provide the data P3P and P1N to the output ports Y2 and Y5, respectively. In the output-path changing circuit 118, the output-path-changing signal 119-1 is provided to the pair of Y1 and Y4, the output-path-changing signal 119-2 is provided to the pair of Y2 and Y5, and the output-path-changing signal 119-3 is provided to the pair of Y3 and Y6. Further, the output-path-changing signal 119-1 is provided to the pair of Y7 and Y10, and so on.

With this configuration, pairs of (6m+1)th and (6m+4)th columns, a pair of Y1 and Y4, a pair of Y7 and Y10, control their output paths based upon the output-path-changing signal 119-1, pairs of (6m+2)th and (6m+5)th columns, a pair of Y2 and Y5, a pair of Y8 and Y11, . . . . , control their output paths based upon the output-path-changing signal 119-2, and pairs of (6m+3)th and (6m+6)th columns, a pair of Y3 and Y6, a pair of Y9 and Y12, . . . , control their output paths based upon the output-path-changing signal 119-3.

Here, due to the reason explained in the first example, that the rearrangement of the display data is needed in a stage preceding the D/A converter, that is, in the shift register circuit or a data latch circuit, in the sixth example also, the output-path-changing signals 119-1, 119-2 and 119-3 are supplied to the output generating circuit 112.

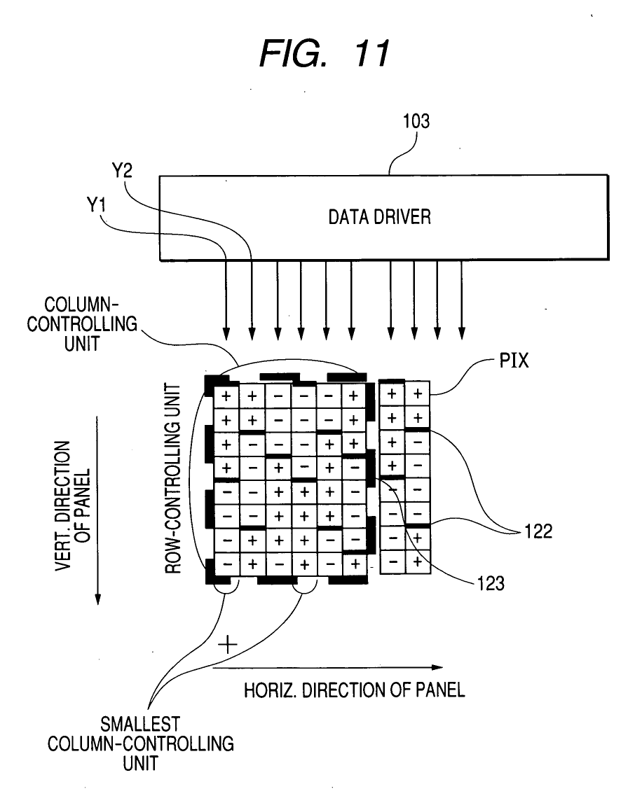

FIG. 11 illustrates the controlling unit for the every-nth-line polarity-inverting ac driving in the liquid crystal display device 100 of the sixth example. In the sixth example, controlling by each of the output-path-changing signals is performed by making the smallest column-controlling unit of a pair of one given output column and another spaced three output columns from the one given output column, a pair of the Y1 and Y4 columns, a pair of the Y2 and Y5 columns, a pair of the Y3 and Y6 columns, . . . , among the signals Y1 to Yn supplied to the liquid crystal display device 100 from the data driver 103, and making the column-controlling unit of six output columns, a group of Y1 to Y6 columns, a group of Y7 to 6 columns, . . . , for the output-path-changing signals. The group of the columns controlled by the output-path-changing signals 119-1, 119-2 and 119-3 of the sixth example explained in connection with FIG. 10 corresponds to one column-controlling unit.

Further, in the sixth example, six output columns are selected to constitute one column-controlling unit. However, it is not always necessary to select six output columns to be one column-controlling unit, but the number of output columns for one column-controlling unit may be increased or decreased. The above configuration can be modified by changing the number of the output-path-changing signals indicated in FIG. 10 using the same algorithm as explained above.

Further, a polarity-inverting row-controlling unit is selected to be eight rows, and is configured to be adjusted by using the signal 110 for setting a repetition period input via the setting pins.

Here, the every-nth-line polarity-inverting ac driving employing the column-controlling unit of M columns and the polarity-inverting row-controlling unit of 2N rows is referred to as the M×N line-inverting ac driving in this specification. By way of example, the M×N line-inverting ac driving 123 illustrated in FIG. 11 is referred to as the 6×4 line-inverting ac driving.

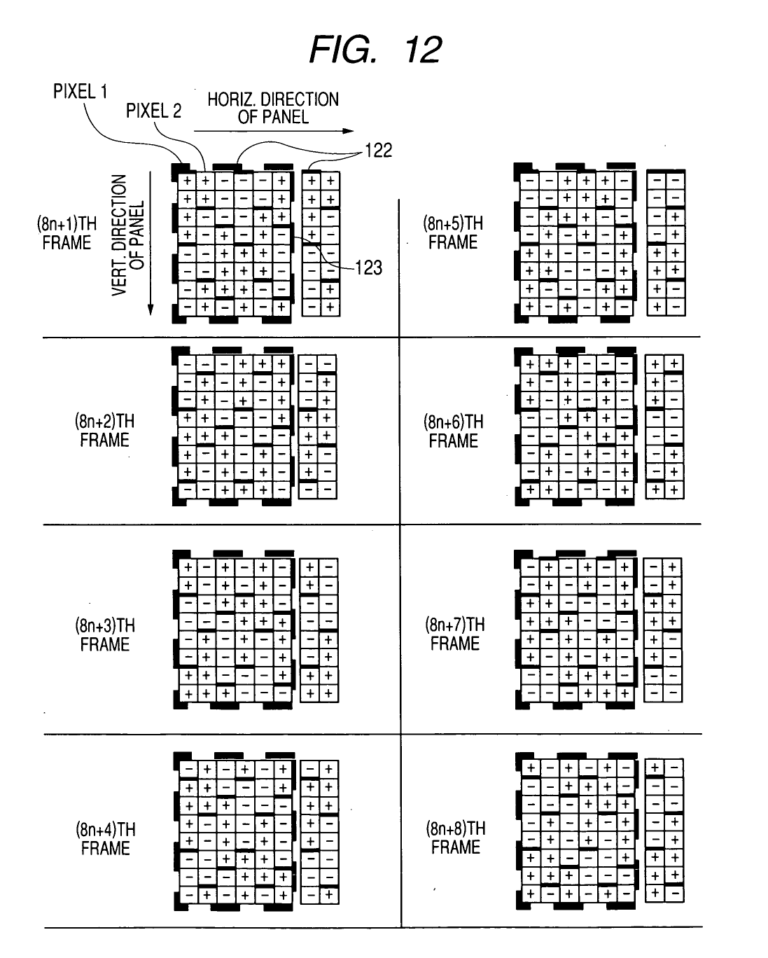

FIG. 12 illustrates a distribution of polarities of voltages applied to respective pixels of the liquid crystal display device 100 in the every-nth-line polarity-inverting ac driving. The sixth example differs from the first example in that the pairs for changing the output paths in the output-path control circuit 113 in FIG. 10 of the sixth example are different from those in FIG. 2 of the first example. FIG. 12 illustrates a distribution of polarities of voltages obtained by applying gray scale voltages to the respective pixels of the liquid crystal display device 100 using the output-path control circuit 113.

In the sixth example, since the output pairs are composed of combinations of (Y1+Y4), (Y2+Y5), (Y3+Y6), the first lines immediately after the inversion of polarities of gray scale voltages of each of the output pairs, (Y1+Y4), (Y2+Y5), (Y3+Y6), . . . , are always displaced from those in adjacent columns in each frame when the first lines are viewed in a direction of extension of the rows of the pixel array. Further, the first lines immediately after the inversion of polarities of gray scale voltages of each of the output pairs, (Y1+Y4), (Y2+Y5), (Y3+Y6), . . . , always shift in a direction of extension of the columns of the pixel array on successive frames from the (8m+1)th frame to the (8m+8)th frame. Further, none of the pixels have applied thereto voltages of the same polarity in three successive frames.

As explained above, while each of the polarity-inverting pairs in the data driver 103 for the every-nth-line polarity-inverting ac driving is composed of two adjacent columns in the first to fifth examples, each of the polarity-inverting pairs in the data driver 103 of the sixth example is configured to be composed of one given column and another column spaced from the one given column by three columns, therefore it is thought that this configuration can realize the feature that make the lines between the adjacent lines of opposite polarities less perceptible, in addition to the features of the first, second, third, fourth and fifth examples. The above advantages can be obtained by applying the configuration of the sixth example to the first to fourth examples.

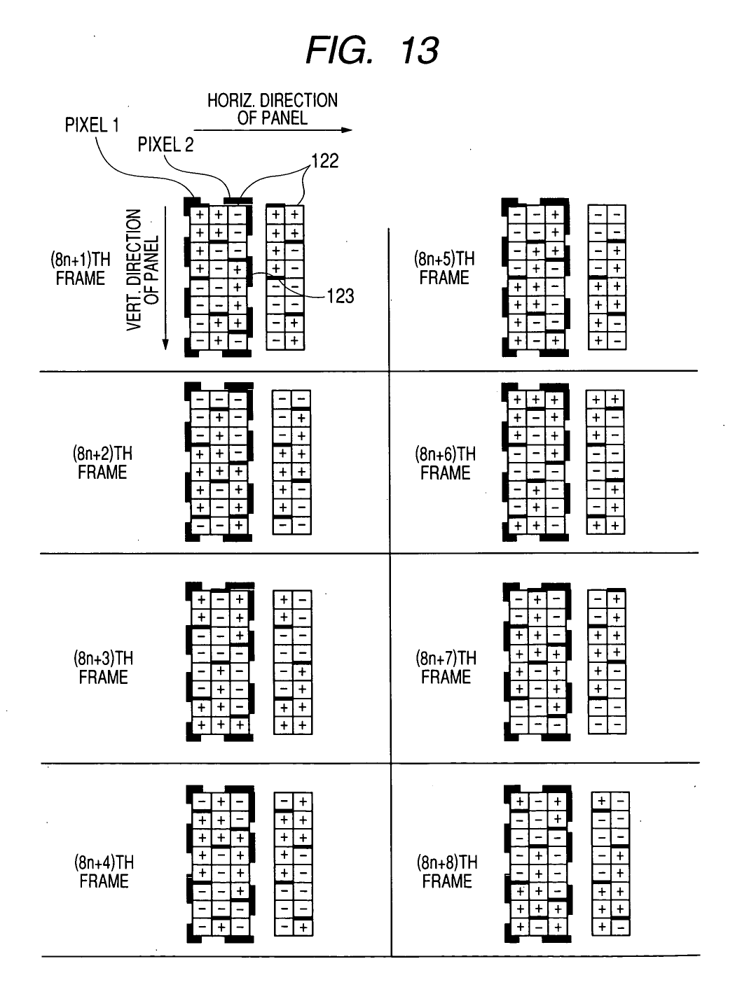

In the following, the seventh example will be explained by reference to FIGS. 1 and 13.

The seventh example has a feature that further disperses spatially the first lines immediately after the inversion of polarities of gray scale voltages in the every-nth-line polarity-inverting ac driving by eliminating the above-explained output pairs explained in the first to sixth examples, in addition to the features of the first, second, third, fourth and fifth examples.

In the seventh example, the driving method and driving device described in the first to fifth examples are realized by controlling the respective outputs which do not form the above-explained output pairs. FIG. 13 illustrates a distribution of polarities of voltages applied to respective pixels of the liquid crystal display device 100 in the seventh example in which gray scale voltages of the polarities and waveforms similar to those in connection with FIG. 4 of the first example are generated with the timing explained in the first example, and they are applied to the respective pixels based upon their output-path-changing signals. The first lines immediately after the inversion of polarities of the applied gray scale voltages of the respective columns are always displaced from those in adjacent columns in each frame when the first lines are viewed in a direction of extension of the rows of the pixel array. Further, in the 3×4 line-inverting ac driving shown in. FIG. 13, the above-explained output pairs are not present which have the first lines immediately after the inversion of polarities of the applied gray scale voltages of the respective columns in the same row in the same frame.

As explained above, the seventh example realizes the further spatial dispersion of the first lines immediately after the inversion of polarities of the applied gray scale voltages of the respective columns by eliminating the output pairs in the data driver which have been used in the first to fifth examples, in addition to the features of the first, second, third, fourth and fifth examples.

1. A driving circuit for a display device which supplies gray scale voltages to a pixel array having a plurality of pixels arranged in a matrix fashion in accordance with display data, and which inverts polarities of said gray scale voltages every plural rows of said pixel array,
said driving circuit for a display device comprising:
a gray scale voltage selector circuit which selects gray scale voltages from among a plurality of gray scale voltages in accordance with said display data; and
a polarity control circuit which controls polarities of said gray scale voltages,
wherein said polarity control circuit controls the polarities of said gray scale voltages such that locations of inversion of polarities of said gray scale voltages in respective columns of said pixel array do not lie in a same row when the locations of inversion of polarities of said gray scale voltages are viewed in a direction of rows of said pixel array.

2. A driving circuit for a display device according to claim 1, further comprising a register for setting the locations of the inversion of polarities of said gray scale voltages, wherein said polarity control circuit controls the polarities of said gray scale voltages based upon information stored in said register on the locations of inversion of the polarities of said gray scale voltages.

3. A driving circuit for a display device according to claim 2, wherein said polarity control circuit inverts the polarities of said gray scale voltages of said pixels on successive frames.

4. A driving circuit for a display device according to claim 2, wherein said polarity control circuit shifts the locations of inversion of the polarities of said gray scale voltages in the respective columns of said pixel array in a direction of the columns of said pixel array on successive frames.

5. A driving circuit for a display device according to claim 2, wherein said polarity control circuit inverts the polarities of said gray scale voltages on alternate columns of said pixel array, and changes the locations of inversion of the polarities of said gray scale voltages every second column of said pixel array.

6. A driving circuit for a display device which supplies gray scale voltages to a pixel array having a plurality of pixels arranged in a matrix fashion in accordance with display data, and which inverts polarities of said gray scale voltages every plural rows of said pixel array,
said driving circuit for a display device comprising:
a gray scale voltage selector circuit which selects gray scale voltages from among a plurality of gray scale voltages in accordance with said display data; and
a polarity control circuit which controls polarities of said gray scale voltages,
wherein said polarity control circuit makes locations of inversion of polarities of said gray scale voltages in a Pth column of said pixel array different from locations of inversion of polarities of said gray scale voltages in columns other than said (P+1)th column of said pixel array when the locations of inversion of polarities of said gray scale voltages are viewed in a direction of rows of said pixel array, and invert the polarities of said gray scale voltages in the (P+1)th column of said pixel array with respect to the polarities of said gray scale voltages in the Pth column of said pixel array.

7. A driving circuit for a display device according to claim 6, further comprising a register for setting the locations of the inversion of polarities of said gray scale voltages, wherein said polarity control circuit controls the polarities of said gray scale voltages based upon information stored in said register on the locations of inversion of the polarities of said gray scale voltages.

8. A driving circuit for a display device according to claim 7, wherein said polarity control circuit changes the locations of inversion of the polarities of said gray scale voltages every two adjacent columns of said pixel array, changes the locations of inversion of the polarities of said gray scale voltages in respective two columns included in 2m columns of said pixel array, and repeats the control for changing of the locations of inversion of the polarities of said gray scale voltages, every 2m columns of said pixel array, where m is an integer equal to or larger than two.

9. A driving circuit for a display device according to claim 8, wherein said polarity control circuit inverts the polarities of said gray scale voltages of the respective pixels on successive frames.

10. A driving circuit for a display device according to claim 8, wherein said polarity control circuit repeats control for changing the locations of inversion of the polarities of said gray scale voltages in respective two columns of said pixel array in successive frames from a first frame to an nth frame, and then changing the locations of inversion of the polarities of said gray scale voltages in respective two columns of said pixel array in successive frames from a (n+1)th frame to a (2n)th frame, from the locations of inversion of the polarities of said gray scale voltages in respective two columns in the first frame to the nth frame, with the polarities of said gray scale voltages of the respective pixels in the (n+1)th frame to the (2n)th frame being inverted from those in the first to nth frames.

11. A driving circuit for a display device according to claim 10, wherein said polarity control circuit shifts the locations of inversion of the polarities of said gray scale voltages in respective two columns of said pixel array in the direction of the rows of said pixel array in successive frames such that each of said pixels do not have same polarities of said gray scale voltages in successive three frames or more.

12. A driving circuit for a display device which supplies gray scale voltages to a pixel array having a plurality of pixels arranged in a matrix fashion in accordance with display data, and which inverts polarities of said gray scale voltages every plural rows of said pixel array,
said driving circuit for a display device comprising:
a gray scale voltage selector circuit which selects gray scale voltages from among a plurality of gray scale voltages in accordance with said display data; and
a polarity control circuit which controls polarities of said gray scale voltages,
wherein said polarity control circuit makes locations of inversion of polarities of said gray scale voltages in a Pth column of said pixel array different from locations of inversion of polarities of said gray scale voltages in an Rth column not adjacent to said Pth column when the locations of inversion of polarities of said gray scale voltages are viewed in a direction of rows of said pixel array, and invert the polarities of said gray scale voltages in the Pth column of said pixel array with respect to the polarities of said gray scale voltages in the Rth column of said pixel array.

13. A driving circuit for a display device according to claim 12, further comprising a register for setting the locations of the inversion of polarities of said gray scale voltages, wherein said polarity control circuit controls the polarities of said gray scale voltages based upon information stored in said register on the locations of inversion of the polarities of said gray scale voltages.

14. A driving circuit for a display device according to claim 13, wherein said polarity control circuit inverts the polarities of two adjacent columns of said pixel array with respect to each other, changes the locations of inversion of the polarities of said gray scale voltages in respective two columns included in 2m columns of said pixel array when the locations of the inversion are viewed in a direction of extension of rows of said pixel array, and repeats the control for changing of the locations of inversion of the polarities of said gray scale voltages, every 2m columns of said pixel array, where m is an integer equal to or larger than two.

15. A driving circuit for a display device according to claim 14, wherein said polarity control circuit inverts the polarities of said gray scale voltages of said respective pixels on successive frames.

16. A driving circuit for a display device according to claim 14, wherein said polarity control circuit repeats control for changing the locations of inversion of the polarities of said gray scale voltages in respective two columns of said pixel array in successive frames from a first frame to an nth frame, and then changing the locations of inversion of the polarities of said gray scale voltages in respective two columns of said pixel array in successive frames from a (n+1)th frame to a (2n)th frame, from the locations of inversion of the polarities of said gray scale voltages in respective two columns of said pixel array in the first frame to the nth frame, with the polarities of said gray scale voltages of the respective pixels in the (n+1) th frame to the (2n)th frame being inverted from those in the first to nth frames.

17. A driving circuit for a display device according to claim 16, wherein said polarity control circuit shifts the locations of inversion of the polarities of said gray scale voltages in respective two columns of said pixel array in the direction of the rows of said pixel array in successive frames such that each of said pixels do not have same polarities of said gray scale voltages in successive three frames or more.

18. A driving circuit for a display device which supplies gray scale voltages to a pixel array having a plurality of pixels arranged in a matrix fashion via a plurality of data lines in accordance with display data,
said driving circuit being provided with an output circuit which outputs to each of said plurality of data lines said scale voltages of one of positive and negative polarities in accordance with said display data,
wherein said output circuit outputs after inverting polarities of said gray scale voltages every group composed of plural ones of said plurality of data lines with an ac driving period shorter than one frame period, and
said ac driving period of said every group is out of phase with respect to each other.

19. A driving circuit for a display device according to claim 18, wherein said driving circuit further comprises a register for setting said ac driving period.

20. A driving circuit for a display device according to claim 18, wherein said ac driving period of said every group is out of phase with respect to each other by a length of time which is shorter than said ac driving period, and is n times a horizontal scanning period where n is a natural number equal to or larger than 1.
